(19) United States
(12) Patent Application Publication
(10) Pub. No.: US 2006/0007196 A1
(43) Pub. Date: Jan. 12, 2006

(54) Panel display control and adjustment

(76) Inventor: Han-Ping Chen, Saratoga, CA (US)

Correspondence Address: Han-Ping Chen, P.O. Box 2871, Saratoga, CA, 95070, US

(21) Appl. No.: 10/860,096

(22) Filed: Jun. 4, 2004

(51) Int. Cl. G09G 5/00

(52) U.S. Cl. 345/204

(57) ABSTRACT

A method and apparatus performs position-oriented adjustments of panel control signals for a flat panel display device in order to correct or compensate for pixel, line, or area defects or distortions such that the display quality meets or approaches a specification level. Also, the present invention provides a method to reduce the adjustment parameter storage by using simplified parametric descriptions.

### BACKGROUND OF THE INVENTION

This invention relates to display panels, panel display controllers, and the position-oriented adjustments of panel control signals.

Flat panel display devices, such as liquid crystal display (LCD) panels are gaining popularity over conventional CRT display devices due to the compact shape, light weight, low power, and low radiation.

Due to certain imperfect, non-uniform, and un-expected phenomena in the panel fabrication process, a display panel may contain defective or distorted display elements or areas. As the dimension and resolution of the display panels increase, it is becoming a production difficulty, a yield limitation and an economical drawback.

After the panel fabrication, certain repairing process may be used to correct minor defects in the display pixel array. However, such process is limited to a relatively small number of pixels. It is impractical for defective or distorted areas that sometimes contain a hundred or more pixels.

As display panels are viewed directly by the users, any imperfectness or distortion are often quite visible. It significantly affects the user perception of the system.

The handling of the imperfectness or distortion is becoming a challenge to the panel fabrication process.

### BRIEF SUMMARY OF THE INVENTION

A display panel is normally used in conjunction with a panel display controller integrated-circuit (IC) chip and a set of panel display driver IC chips. This invention proposes a method and apparatus to correct panel display defects, or significantly improve the panel display quality with adjustment mechanisms on the display controller and display driver IC side.

This invention provides a method that utilizes position-oriented adjustments of panel control signals to compensate the effects of pixel, line, and area defects such that the display quality matches or approaches a specified level.

The present invention provides a method to store, retrieve, and modify the position-oriented adjustment parameters for maximum flexible and utilization.

This invention further provides a method to reduce the adjustment parameter storage requirements by using simplified parametric descriptions.

### BRIEF DESCRIPTION OF THE DRAWINGS

FIG. 1 is a diagram of a prior art panel display system.

FIG. 2 shows a preferred embodiment of the present invention for a panel display system with control and driving units.

FIG. 3 shows a preferred embodiment of the present invention for a panel display controller.

FIG. 4 shows an example for the contents of a display memory unit and a panel status memory unit.

FIG. 5 shows some alternative formats for the panel status unit.

FIG. 6 shows another preferred embodiment of the present invention for a panel display control and driving system.

### DETAILED DESCRIPTION OF THE INVENTION

The present invention will be illustrated with some preferred embodiments.

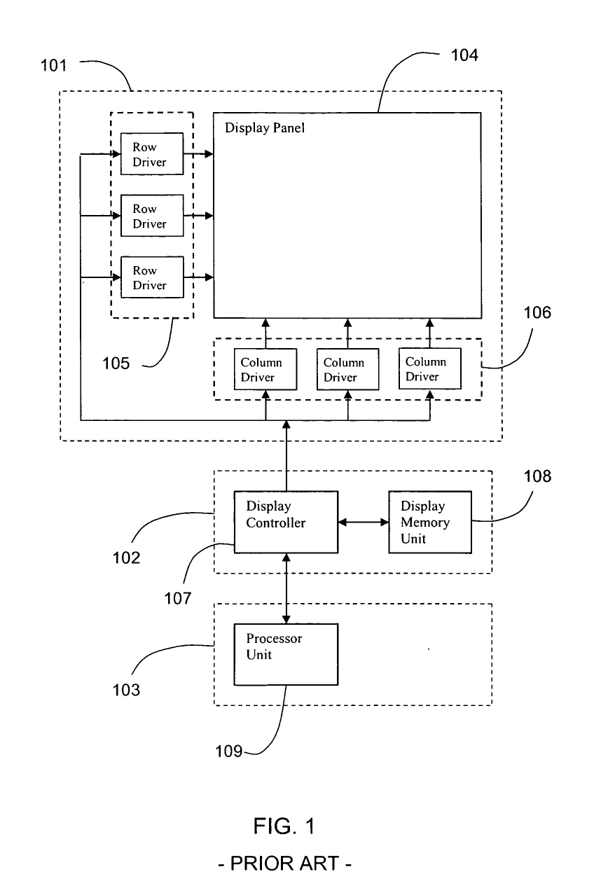

FIG. 1 is a diagram of a prior art panel display system. The panel display system consists of a panel display subsystem 101, a panel control subsystem 102, and a processor subsystem 103. The panel display subsystem 101 includes a flat panel display device 104 with an array of pixel elements.

For monochrome liquid crystal display (LCD) panels, at each pixel position, a pixel element assumes two states, an ON state to let the backlight pass through, and an OFF state to block the backlight from passing through. For color display, a pixel element consists of three sub-elements, each controlling a primary color.

The ON and OFF states of the pixel elements are controlled by the combination of a set of row drivers IC chips 105 and a set of column drivers IC chips 106. The row drivers select a current row. The column drivers select a current column. The proper timing sequence of the control signals from the row drivers and column drivers determines the color and grey levels of each pixel element.

The row and column drivers receive the color level information for each pixel from the panel control subsystem 102. The control subsystem 102 contains a display controller 107. It usually also maintains a display memory unit 108 to keep pixel data and other variables.

The display controller 105 receives commands from the processor subsystem 103. The processor subsystem 103 contains a processor unit 109. It may also contain other memory and input-output devices.

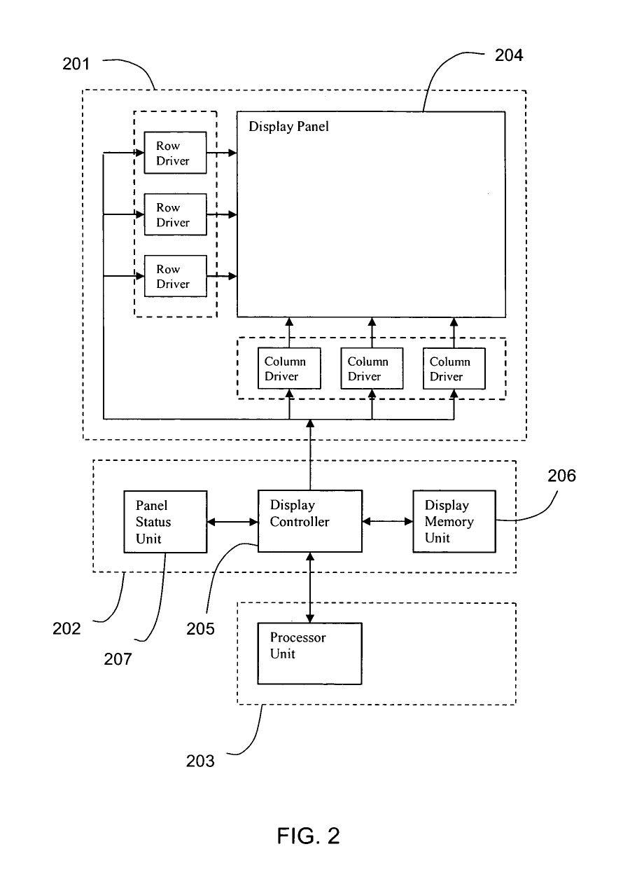

FIG. 2 shows a preferred embodiment of the present invention for a panel display system with control and driving units. The panel display system consists of a panel display subsystem 201, a panel control subsystem 202, and a processor subsystem 203.

The panel display subsystem 201 is functionally the same as the panel display subsystem 101 in FIG. 1 to maintain compatibility. Likewise, the processor subsystem 203 is also functionally the same as the processor subsystem 103 in FIG. 1.

However, in this case, the panel display subsystem 201 includes a flat panel display device 204 that contains certain defective pixels, lines, or areas. It is up to the present invention to correct or compensate these panel defects to a specified level.

The primary function of the present invention is embedded in the panel control subsystem 202. The panel control subsystem 202 contains a display controller 205, a display memory unit 206, and a panel status unit 207.

The panel status unit 207 keeps the position-oriented data of the defective pixels, lines, or areas in the associated flat panel display device 204.

The display controller 205 uses the panel status data to adjust the pixel data according to a set of pre-determined criteria and formula. These criteria and formula are determined according to the defective types.

Panel defective types may be classified by the scope, the shape, the pattern, the source, and the affected regions.

The scope of the defects may be in pixels, lines, or areas. For area defects, the shape may be in stripes, circles, or ellipse. For line defects, the shape may be horizontal, vertical, or diagonal.

For pixel defects, the pattern may be a function of the brightness, including a constant bright pixel or dark pixel. For area defects, the pattern may be a linear or non-linear function of the relative position from a reference point, such as a center point.

The sources of the defects include the non-uniform distribution of the liquid crystal material, the imperfectness of the panel fabrication process, or the intensity variation of the backlight. Possible sources also include minor physical defects of the photo-mask, foreign particles, or minor damages to the base glass.

A percentage of the panel defects are incurable. Some panel defects are curable only by physical repairs. Yet a large percentage of the panel defects may be corrected or compensated by adjustments.

Since these panel defects are position-oriented, the adjustments also need to be position-oriented.

A panel display system with proper adjustment and compensation can increase the number of usable panels. The cost-effectiveness and performance of such a system depends on the pre-determined coverage of the panel defects.

A higher coverage of panel defect types and variations will generate higher yield on panel production. On the other hand, it also increases the complexity of the display controller and the associated memory storage for adjustment parameters.

However, the cost of the panel is the dominating cost factor of the system cost. The incremental cost of the controller or memory is only a fraction of total amount.

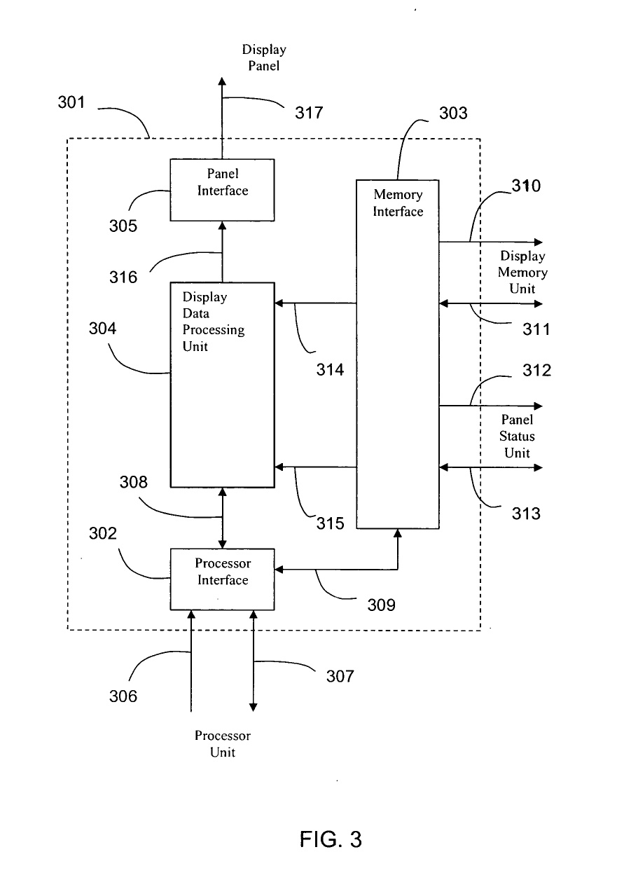

FIG. 3 shows a preferred embodiment of the present invention for a panel display controller. The panel display controller 301 includes a processor interface 302, a memory interface 303, a display data processing unit 304, and a panel interface 305.

The processor interface 302 enables a processor unit to send command and control signals through processor control lines 306, and to read and write data through processor data lines 307.

Upon commands from the processor unit, the processor interface 302 controls the display data processing unit 304 through control lines 308, or control the memory interface 303 through control lines 309.

The memory interface 303 sends timing and control signals to a display data memory unit through display data memory control lines 310, and accesses display memory data through display memory data lines 311.

The memory interface 303 also sends timing and control signals to a panel status unit through panel status control lines 312, and accesses panel status data through panel status data lines 313.

The display memory data and the panel status data may reside in separate memory units, or in the same memory unit.

The display data processing unit 304 receives display memory data 314 and panel status data 315, and performs a pre-defined adjustment operation.

Panel interface 305 receives the display data output 316 from display data processing unit 304. The display data output is sent to a display panel device through panel data lines 317.

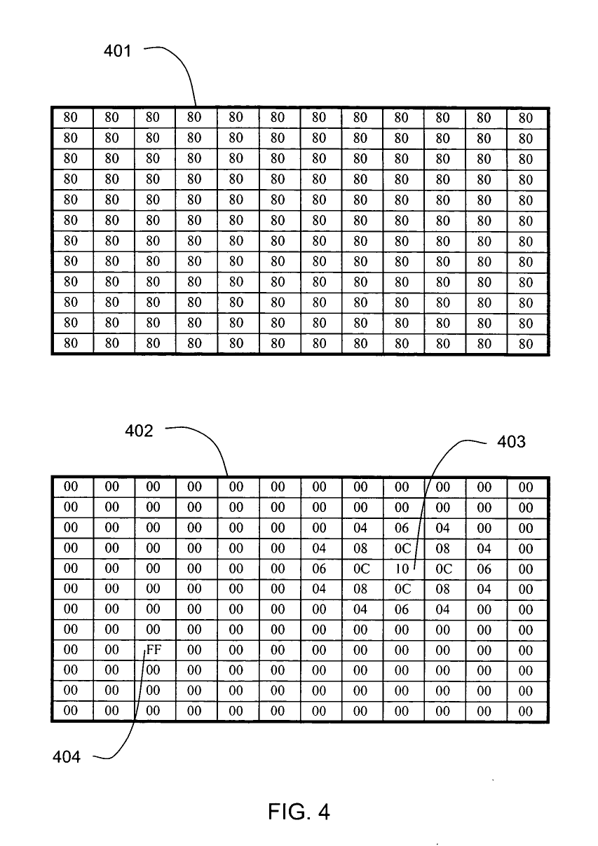

FIG. 4 shows an example for the contents of a display data memory unit and a panel status unit.

The contents of the display data memory unit 401 are shown in a simplified fashion, with a monochrome pixel array of 12 rows by 12 columns. Each pixel cell in the array is shown with an 8-bit value, for a total of 256 grey scales. In FIG. 4, all the cells in 401 are shown with a hexadecimal value of 80, a half-saturated grey level.

The contents of the panel status unit 402 are shown with a pixel array of the same size. Each pixel cell in the array is also shown with an 8-bit value. In this embodiment, this value is used as an adjustment factor. A multiplication factor is defined as 256 minus the adjustment factor value of the panel status memory. An adjustment factor of 0 corresponds to a multiplication factor of 256.

For each pixel cell, the value of the display memory is multiply by the multiplication factor. The 8 lower-order bits of the result are then dropped to scale down the multiplication effect by 256. The effective multiplication scale is therefore normalized to 1.

An adjustment factor of 0, with a multiplication factor of 256, will yield the same value for the display data, indicating no adjustment.

An adjustment factor of 1, with a multiplication factor of 255, will produce a display data value that is 255/256 of the original display data value.

An adjustment factor of 255, with a multiplication factor of 1, will produce a display data value that is 1/256 of the original display data value. Since the maximum value of the original display data is 255, and a value of 255/256 is below the significant digit range, the final integer result for the display data is 0.

The contents of the panel status unit 402 shows a defective area centered at pixel position 403. At pixel position 403, the adjustment factor is hexadecimal 10, which corresponds to a multiplication factor of hexadecimal F0.

For the 4 pixel positions with a pixel distance of 1 from pixel position 403, the adjustment factor is hexadecimal 0C. As the pixel distance from pixel position 403 increases, the adjustment factor decreases.

With a panel display controller as shown in FIG. 3, for each pixel cell, the panel display controller 301 reads the display pixel data, as illustrated in 401, through memory interface 303 from the display data memory unit. The panel display controller 301 also reads the panel status data, as illustrated in 402, through memory interface 303 from the panel status unit.

The display controller 301 uses the panel status data 315 to adjust the pixel data 314 in the display data processing unit 304 according to the multiplication operation described above to generate the adjusted final pixel data 316 and send it to the panel display subsystem.

In FIG. 4, the panel status memory 402 also contains an entry at pixel position 404, with an adjustment factor of hexadecimal FF, or decimal value 255. The pixel data at pixel position 404 is essentially blocked.

This is to prevent a defective pixel from displaying a constant bright spot, which is more visible than a constant dark spot.

The formula performed in FIG. 4 is a linear multiplication. A modified linear formula includes adding an offset value to the result of the multiplication. To accommodate the additional parameter, the size of the panel status memory may increase. Alternatively, an offset value may also be defined as a function of the adjustment factor.

To achieve higher accuracy in the pixel data adjustment operation, certain nonlinear formula may also be used. There is a trade-off between adjustment accuracy and cost of implementation.

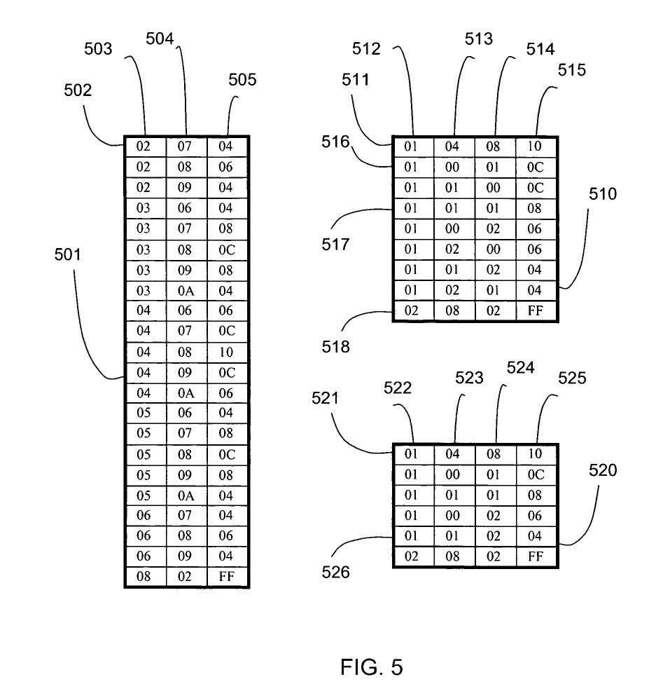

FIG. 5 shows some alternative formats for the panel status unit. An adjustment factor list 501 includes only the pixel positions which require adjustments.

An adjustment entry 502 in the list contains a row number field 503, a column number filed 504, and an adjustment factor field 505. The adjustment entry 502 specifies that the pixel cell at row 02 and column 07 requires an adjustment factor of 04.

Since the panel size is normally quite large, for example 1024 columns by 768 rows, the cost reduction can be quite significant.

A parametric description 510 further reduces the memory requirements for panel status. To describe an area, it specifies only the adjustment factors for the center point and a list of relative distances from the center point.

An adjustment entry 511 in the list contains a group identification number field 512, a row field 513, a column filed 514, and an adjustment factor field 515.

The first adjustment entry in a group specifies the center point. In a center point entry, the row field specifies the row number and the column field specifies the column entry. Therefore, the adjustment entry 511 specifies that the center of the first group is the pixel cell at row 04 and column 08, which requires an adjustment factor of 10.

Group entries following the center point entry are surrounding point entries. In a surrounding point entry, the row field specifies the relative row distance from the center point. The column field specifies the relative column distance from the center point.

Adjustment entry 516 specifies that any pixel cell with a relative row distance of 00 and column distance of 01 from the center point requires an adjustment factor of hexadecimal 0C.

Two pixel cells qualify for such a condition, namely, the pixel cell at row 04 and column 07 and the pixel cell at row 04 and column 09.

Adjustment entry 517 specifies that any pixel cell with a relative row distance of 01 and column distance of 01 from the center point requires an adjustment factor of 08.

Four pixel cells qualify for such a condition, namely, the pixel cell at row 03 and column 07, the pixel cell at row 03 and column 09, the pixel cell at row 05 and column 07, and the pixel cell at row 05 and column 09.

Adjustment entry 518 starts a new group number 02, with just one entry, specifying the center point. The center point is the pixel cell at row 08 and column 02, with an adjustment factor of hexadecimal FF, blocking out the pixel display.

A parametric description 520 specifies the panel status in an even more condensed fashion. The description is quite similar to 510 except that the row distance and column distance for the surrounding points are treated as symmetrical.

An adjustment entry 521 still contains a group identification number field 522, a row field 523, a column filed 524, and an adjustment factor field 525.

The center point entry 521 still specifies that the center of the first group is the pixel cell at row 04 and column 08, which requires an adjustment factor of hexadecimal 10.

However, the surrounding point entry 526 specifies that any pixel cell either with a row distance 01 and a column distance 02, or with a row distance 02 and a column distance 01 requires an adjustment factor 04.

A total of 8 pixel cells qualify for such a condition. They are all processed the same way.

The pixel data adjustment can be performed pixel by pixel, segment by segment, line by line, or screen by screen.

When the display data is frame-buffer-based, and the pixel data adjustment is performed screen by screen, a simplified adjustment factor list will not only reduce the storage requirements, but also reduce processing time.

When the display data is line-buffer-based, and the pixel data adjustment is performed line by line, certain line-level pre-processing can be performed to prepare for the pixel-level adjustment operations.

Similar pre-processing can be performed for segment-by-segment data adjustment to prepare for the pixel-level adjustment operations. Segment-by-segment processing is performed to utilize the page-oriented access mode of certain memory devices.

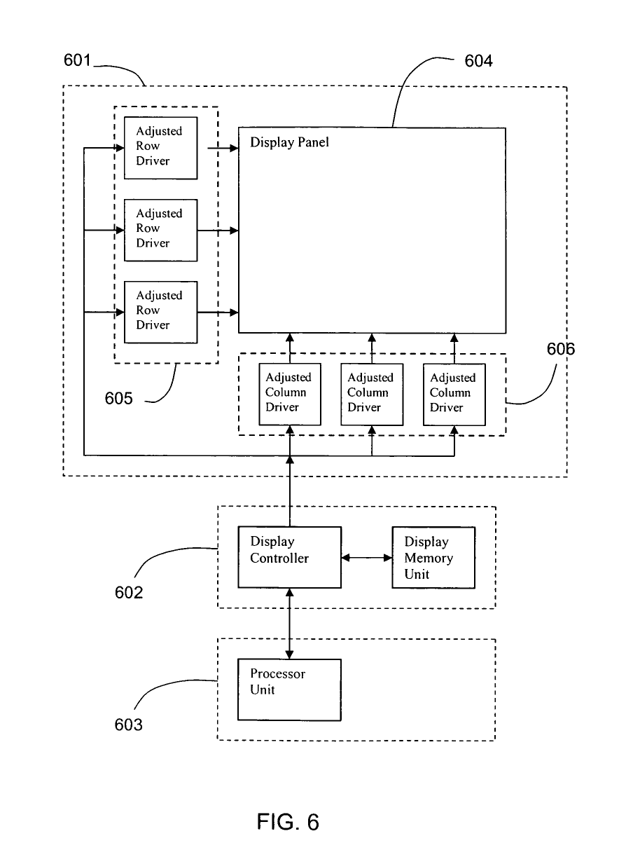

FIG. 6 shows another preferred embodiment of the present invention for a panel display system with control and driving units. The panel display system consists of a panel display subsystem 601, a panel control subsystem 602, and a processor subsystem 603.

The panel control subsystem 602 and the processor subsystem 603 are functionally the same as the panel control subsystem 102 and the processor subsystem 103 in FIG. 1 to maintain compatibility.

The panel display subsystem 601 includes a flat panel display device 604 that contains certain defective pixels, lines, or areas.

In this preferred embodiment, the adjustment function is embedded in the panel driver integrated circuits.

The panel display subsystem 601 includes a set of adjusted row drivers 605 and a set of adjusted column drivers 606.

The display data adjustments and the panel status descriptions are distributed among the row drivers 605 and column drivers 606.

As another preferred embodiment, the display data adjustments and the panel status descriptions may also be distributed among a display controller and a set of row and column drivers.

In a panel display system, the panel control and driving circuits may be allocated among one or more integrated-circuit (IC) display controllers and a set of IC panel drivers. These display controllers and panel drivers may be referred as panel controlling devices.

In general, a set of panel drivers resides with the display panel in a display subsystem, sometimes referred to as a display panel module. However, a display panel module may also include a display controller for additional functions.

The partitioning boundaries of these panel controlling devices depend on the functional requirements, cost effectiveness, or physical constraints.

1. A panel display controlling device comprising:
(a) a display data input unit;
(b) a display data output unit;
(c) a panel status unit;
(d) a display data control unit;
wherein said display data input unit receives panel display data inputs from a data source;
wherein said display data output unit sends panel display data outputs directly or indirectly to a display panel;
wherein said panel status unit supplies a plurality of panel status entries which contain position-oriented panel data of defective pixels, lines, or areas;
wherein said display data control unit performs position-oriented adjustment operations to said panel display data inputs according to said panel status entries to generate said panel display data outputs.

2. The panel display controlling device of claim 1, wherein said display data input unit is a processor interface.

3. The panel display controlling device of claim 1, wherein said display data input unit is a memory interface.

4. The panel display controlling device of claim 1, wherein said display data input unit is a data stream interface.

5. The panel display controlling device of claim 1, wherein said display data input unit is an interface to a prior-stage panel display controlling device.

6. The panel display controlling device of claim 5, wherein said prior-stage panel display controlling device is a panel display controller integrated circuit (IC) chip.

7. The panel display controlling device of claim 1, wherein said display data output unit is an interface to a display panel.

8. The panel display controlling device of claim 1, wherein said display data output unit is an interface to a post-stage panel display controlling device.

9. The panel display controlling device of claim 8, wherein said post-stage panel display controlling device is a panel driver integrated circuit (IC) chip.

10. The panel display controlling device of claim 1, wherein said display data output unit is a memory interface.

11. The panel display controlling device of claim 1, wherein said panel status unit is a memory storage which stores position-oriented adjustment parameters.

12. The panel display controlling device of claim 1, wherein said panel status unit is a memory interface.

13. The panel display controlling device of claim 1, wherein said panel status unit is a data interface which receives panel status entries from an external source.

14. The panel display controlling device of claim 1, wherein two or more of said panel status unit, said display data input unit, or said display data output unit share the same memory interface.

15. A panel display controlling device comprising:
(e) a display data input unit;
(f) a display data output unit;
(g) a panel status unit;
(h) a display data control unit;
wherein said display data input unit receives panel display data inputs from a data source;
wherein said display data output unit sends panel display data outputs directly or indirectly to a display panel;
wherein said panel status unit supplies a plurality of panel status entries which contain position-oriented panel adjustment parameters;
wherein said display data control unit performs position-oriented adjustment operations to said panel display data inputs according to said panel status entries to generate said panel display data outputs.

16. The panel display controlling device of claim 15, wherein two or more of said panel status unit, said display data input unit, or said display data output unit share the same memory interface.
